(19) United States
(12) Patent Application Publication
(10) Pub. No.: US 2005/0279710 A1
(43) Pub. Date: Dec. 22, 2005

(54) Wastewater treatment apparatus and method of treating wastewater

(76) Inventor: William E. Clemons SR., Chesapeake, VA (US)

Correspondence Address: LADAS & PARRY LLP, 224 SOUTH MICHIGAN AVENUE, SUITE 1600, CHICAGO, IL, 60604, US

(21) Appl. No.: 10/869,081

(22) Filed: Jun. 16, 2004

(51) Int. Cl. C02F 1/52

(52) U.S. Cl. 210/702; 210/205; 210/387

(57) ABSTRACT

An apparatus and method for treating wastewater with a flocculent. The wastewater is mixed with a flocculent so that the contaminants and pollutants within the water are absorbed by the flocculent. The mixture is then transported to a gravity bed filter having a filter media conveying means. The filter media is conveyed to a second end as the mixture is transported to the first end. Clean water seeps from the mixture and is collected in a basin. Thus, the wastewater treatment may continuously operate without interruption. Such an apparatus offers the advantage of possibly being made smaller in size than typical wastewater treatment plants and thus may be made mobile.

### FIELD OF THE INVENTION

The invention relates generally to wastewater treatment equipment. The invention relates more particularly to an apparatus for the continuous treatment of wastewater and method thereof, using a flocculent clay-based powder.

### BACKGROUND OF THE INVENTION

A clean and healthy water supply is vital to society. The need therefore exists to remove waste products from contaminated and polluted water, referred herein throughout this specification as wastewater. Various systems have been developed to treat wastewater. Many such systems are designed as large fixed location wastewater treatment plants. However, as governmental mandates are increasingly implemented to regulate the production and disposal of wastewater, and the by-products produced by the treatment thereof, the need for smaller waste treatment facilities with mobile capabilities increases to treat wastewater which is produced or located at locations remote from conventional wastewater treatment plants.

A significant source of wastewater is cleaning equipment which use water as the primary cleaning fluid. The wastewater created by this cleaning equipment typically contains oils, greases, suspended solids, heavy metals, diesel fuel, emulsions, latex paints, and other similar hydrocarbon and metallic contaminants. Even if the wastewater is filtered to remove these contaminants and pollutants, it is difficult to safely and economically dispose of the filtered waste by-products.

One known wastewater treatment system that can be produced on a smaller scale uses a clay-based powder (such as Montmorillonite and a cationic polymer) as a flocculent to remove emulsified oils and metals from water. The acids in the powder break the oil emulsion. The oil and other contaminants are fixated within the clay-based powder through a process of flocculation and encapsulation. The floc settles to the bottom, or floats to the top, of the water treatment tank, with mostly clear water therebetween. The floc is separated from the mostly clear water and may then be further filtered to further remove some excess water included with the floc.

The cleaned water may then be either recycled for further use or safely discharged to the environment, sewer system, storm drains or sewer treatment system. The entrapped contaminants and pollutants form a sludge with clay-based powder which may be suitable for disposal in a Class II non-hazardous industrial landfill.

U.S. Pat. No. 5,979,012 teaches a mobile clay-based flocculent wastewater apparatus using this technology. That apparatus collects the wastewater, then mixes the wastewater with flocculent to allow complete encapsulation of the contaminants. The mixture is then allowed to settle for a few minutes so that the floc settles to the bottom and/or floats to the top (depending on the contaminants and pollutants), and a volume of mostly clear water forms. Then, the mostly clear water volume is first transferred and filtered through a filter cloth through which only clean water may pass. The remaining sludge is then transferred onto the filter cloth and more clean water is filtered from the sludge. The clean water is retained in a storage tank for further use or disposal. The remaining sludge may then be wrapped in the filter cloth and properly disposed of.

The above-described process for treating the wastewater with the apparatus of U.S. Pat. No. 5,979,012 is known as a batch process. In other words, only a certain volume of wastewater is treated at a time, and no new wastewater is introduced into the system until treatment of the wastewater being processed is completed. While this process is acceptable for some applications, for use on cleaning equipment it would be advantageous for the treatment process to be continuous so that the cleaning operation did not need to be stopped while the wastewater is being treated, or for large amounts of wastewater to be stored. Thus, a need exists for a wastewater treatment apparatus which has mobile capabilities and affords a continuous and uninterrupted treatment operation.

### SUMMARY OF THE INVENTION

Embodiments of the present invention may provide a wastewater treatment apparatus utilizing a clay-based flocculent powder. Incoming wastewater is mixed with the flocculent powder so that contaminants and pollutants within the water are encapsulated with the flocculent. The mixture, otherwise known as floc, is then filtered to separate the clean water from the floc. The clean water may then be reused or disposed of. The remaining floc sludge may then be safely disposed of

Prescribed amounts of wastewater and flocculent powder may be continuously added to the mixture in a mixing tank, and floc continuously transferred from the mixing tank to be filtered. The floc is transferred to a gravity bed filter where clean water is separated from the floc. The gravity bed filter includes a conveyor belt which is covered with a layer of filter media.

The filter media is provided in a long continuous length and is moved over the conveyor belt as the floc is deposited thereon. Clean water seeps out of the floc through the filter media and collects in a clean water storage tank. The remaining sludge adheres to the filter media and is deposited in a disposal container for later disposal.

Embodiments of the present invention are particularly well suited for use with cleaning equipment with which a continuous supply of water is used during the cleaning operation, or other applications where mobility is needed.

### BRIEF DESCRIPTION OF THE DRAWING FIGURES

FIG. 1 is a partially schematic broken side elevation of a preferred embodiment of the invention.

FIG. 2 is an enlarged and partially schematic view of the mixing tank and gravity bed filter shown in FIG.1.

FIG. 3 is an enlarged and partially schematic view of an alternative configuration for the gravity bed filter.

### DETAILED DESCRIPTION OF THE PREFERRED EMBODIMENT

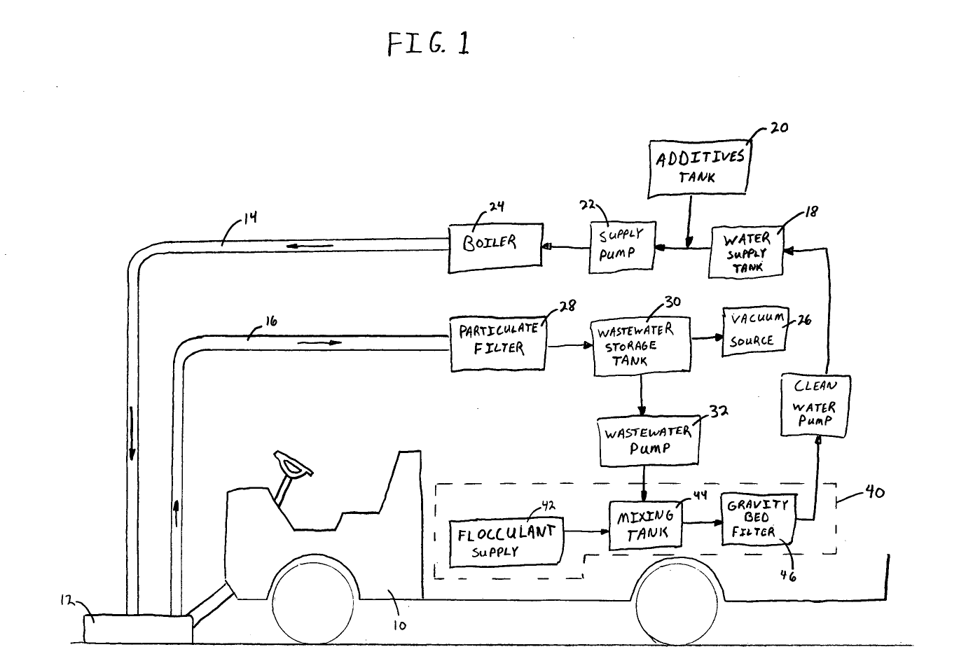

FIG. 1 shows the wastewater treatment apparatus in conjunction with a surface cleaner mounted on a mobile platform 10. The mobile platform 10 may be any vehicle, such as the truck which is shown, or trailer, ship, airplane, train, etc. A cleaning head 12 is mounted to the mobile platform 10 for cleaning of a surface. Cleaning fluid is provided to the cleaning head 12 via a supply conduit 14, and the cleaning fluid is removed from the cleaned surface via a suction conduit 16.

Water is supplied from a water supply tank 18 and/or from a municipal water source. Cleaning additives such as detergents, degreasers and coalescents may be added to the supply water from an additive tank 20. The water passes through a supply pump 22 to increase the pressure at which the cleaning fluid is to be supplied to the cleaning head 12, or other surface cleaning implement such as a wand sprayer or brush. A boiler 24 may be provided if the cleaning fluid is to be supplied at an elevated temperature or as steam.

After the cleaning fluid is applied to the surface, the cleaning fluid with entrapped contaminants pollutants and particulates removed from the surface are transported via suction conduit 16 to the wastewater treatment apparatus. Typically, suction of the cleaning fluid is provided by some suction means such as a vacuum source, fluid pump, fan, cyclone, etc. The preferred embodiment shown in FIG. 1 utilizes a vacuum source 26 by which air flow into the cleaning head 12 and out the suction conduit 16 provides the suction for transporting the cleaning fluid with entrapped contaminants, pollutants and particulates, which will now be defined as wastewater.

From the suction conduit 16 the wastewater passes through a particulate filter 28 to separate out any gross particulate matter such as cigarette butts, gum, sticks and stones. The filtered wastewater is then collected in a wastewater storage tank 30. The storage tank 30 may be an oil/water separator in which oil is separated from the wastewater before the flocculent treatment. The storage may also be a solids separator in which some suspended solids in the wastewater may settle and be separated from the wastewater. The storage tank 30 may function as both an oil/water separator and a solids separator, which is commonly known as an oil/water solids separator. The wastewater is then transported to the wastewater treatment apparatus 40 for treatment. The wastewater may be gravity fed to the wastewater treatment apparatus 40 or a wastewater pump 32 may be used if necessary depending on configuration.

The particulate filter 28 may comprise any device for filtering out gross particulates, and each are intended to be coved by the definition of particulate filter. Examples of particulate filters include bag filters, cyclone filters, etc.

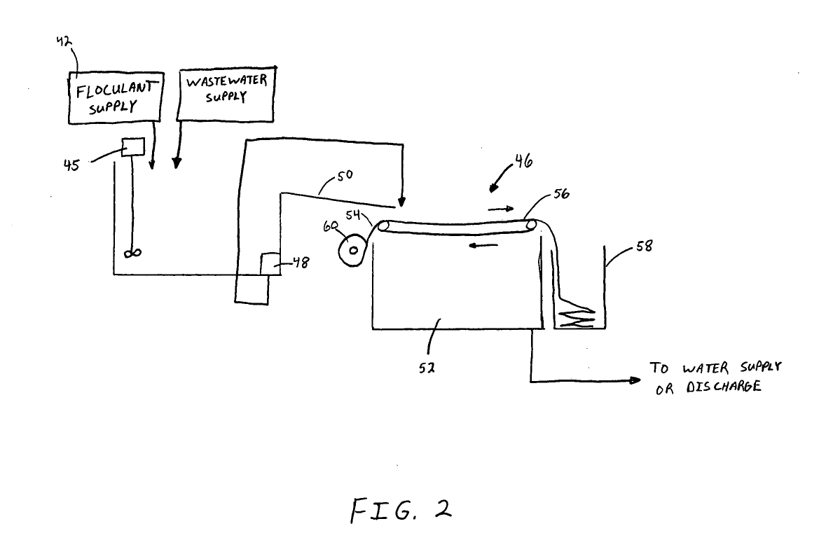

The wastewater treatment apparatus 40 includes a flocculent supply 42, a mixing tank 44, a gravity bed filter 46, and clean water basin 52, which are shown in more detail in FIG. 2.

Wastewater and flocculent are supplied into the mixing tank 44 in predetermined amounts. Determination of the amount of flocculent to be used may be made by the operator depending on the application of the apparatus and condition of the wastewater. Determination of the amount of flocculent to be used may also be automatically controlled in response to signals from a contaminant sensor (not shown) in the incoming stream of wastewater entering the mixing tank 44.

A mixer 45 is provided in the mixing tank 44 and generates a sufficient amount of shear to allow for flocculation of the mixture, and encapsulation and absorption of the contaminants and pollutants by the clay platelets. The clay flocculent surrounds oils, emulsions, suspended solids, and heavy metals, forming a floc mixture. The floc will tend to rise to the top or settle to the bottom of the mixing tank 44, depending upon the contaminant/pollutant which has attached to the clay platelets. The floc may then be transported to the gravity bed filter 46. Various means of transporting the floc are possible. A sump pump 48 may be provided at the bottom of the mixing tank 44. Also, a raceway 50 may be provided at a top edge of the mixing tank 44 for floc to spill over and flow to the gravity bed filter 46.

The mixer 45 shown in FIG. 2 comprises a motor having a shaft and an impeller. However, any device which creates turbulence in the mixing tank may be used and is intended to be included within the definition of a mixer. Examples of other types of mixers include pumps, paddlewheels, gases pumped through the mixture, magnetically driven rotators, etc.

The gravity bed filter 46 includes filter media 54, filter media conveying means 56 that conveys and suspends the filter media 54 over the clean water basin 52, and a filter media waste container 58.

The filter media 54 is supplied from a large capacity filter media supply means 60, such as a large roll, as a continuous sheet over the filter media conveying means 56. The filter media conveying means 56 may comprise a conveyor belt assembly or other device to convey the continuous supply of filter media 54 over the clean water basin 52. The floc is transported at a first end of the filter media conveying means 56 on the filter media 54. Clean water may then seep out of the floc and through the filter media 54 to be collected in the clean water basin 52, as the floc and paper media is conveyed over the clean water basin 52. The filter media 54 may be conveyed at a predetermined rate or in response to the accumulation of floc on the filter media 54. At a second end of the filter media conveying means 56 the filter media 54 and remaining floc sludge are collected in a filter media waste container 58 for later disposal.

The clean water collected within basin 52 may then be discharged for reuse or disposal, selection of which may be controlled by a valve (not shown). A clean water pump 62 may be provided if necessary.

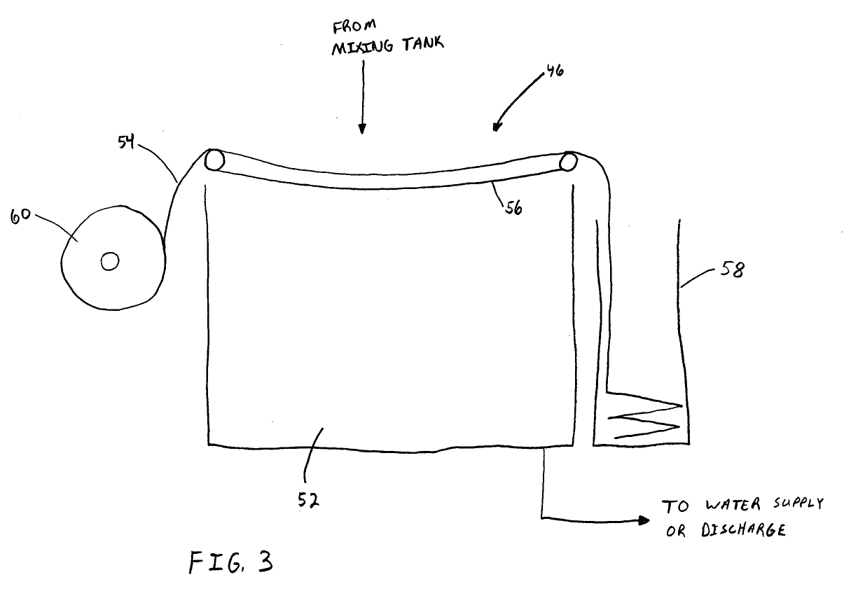

FIG. 3 shows an enlarged view of an alternative embodiment of the gravity bed filter 46. In this embodiment there is a more noticeable, and intend, sloping of the filter media conveying means 56 near the center thereof. The floc mixture is transported from the mixing tank 44 near the center of the filter media conveying means 56. The floc tends to bind and clog the filter media 54, thus preventing adequate seepage of the water therethrough and into the clean water basin 52. With the sloped or bowed configuration of the filter media conveying means 56, water will tend to pool, possibly between an upper and lower layer of floc. A float switch (not shown) may then be provided so that if a predetermined amount of water pools or accumulates at the center the filter media conveying means will be activated by the float switch and an amount of filter media 54 will be advanced to expose the accumulated water to a portion of filter media 54 which has not been clogged by the floc. Thus, the accumulated water may then seep through the filter media and into basin 52. The advantage of this embodiment is that only the necessary amount of filter media to allow for seepage of the water is advanced, preventing waste of the filter media.

The filter media 54 may be made of any porous material that allows the clean water to seep therethrough while retaining the flocculent sludge. Filter media preferably is constructed of paper or cloth. However, the use of other materials is possible, such as metal, plastic, or ceramics.

While the above-preferred embodiment is shown and described in conjunction with a surface cleaning device, the wastewater treatment apparatus may be used separately or in conjunction with various other devices. Although the invention has been described relative to the above-specific embodiment, there are numerous variations and modifications that will be readily apparent to those skilled in the art in light of the above teachings. It is therefore to be understood that the intended scope of protection for the invention is only limited by the scope of the claims appended hereto.

1. A wastewater treatment apparatus comprising:
a mixing tank;
a gravity bed filter, including filter media, a filter media conveying means, and a filter media waste container; and
a clean water basin;
wherein wastewater and a flocculent are mixed within said mixing tank, and the mixture is transported to said gravity bed filter;
wherein said filter media is conveyed and supported by said filter media conveying means over said clean water basin;
wherein said mixture is transported to a first end of said filter media conveying means and disposed on said filter media so that clean water seeps from said mixture and through said filter media to collect in said clean water basin;
wherein said mixture is conveyed on said filter media to a second end of said filter media conveying means.

2. The wastewater treatment apparatus of claim 1 wherein said apparatus is provided on a mobile platform.

3. The wastewater treatment apparatus of claim 1 further comprising a filter media waste container in which said filter media and said mixture are collected at said second end of said filter media conveying means.

4. The wastewater treatment apparatus of claim 1 further comprising a mixer in said mixing tank.

5. The wastewater treatment apparatus of claim 1 wherein said filter media comprises a paper filter.

6. The wastewater treatment apparatus of claim 1 wherein said filter media comprises a cloth filter.

7. The wastewater treatment apparatus of claim 1 wherein said filter media comprises a fine mesh screen.

8. The wastewater treatment apparatus of claim 1 wherein said filter media is continuously supplied from a filter media supply means.

9. The wastewater treatment apparatus of claim 8 wherein said filter media supply means is a roll of filter media.

10. The wastewater treatment apparatus of claim 1 further comprising a sump pump to transport said mixture from said mixing tank to said gravity bed filter.

11. The wastewater treatment apparatus of claim 1 further comprising a raceway by which said mixture may flow from said mixing tank to said gravity bed filter.

12. The wastewater treatment apparatus of claim 1 further comprising a suction means used to introduce raw wastewater into the apparatus.

13. The wastewater treatment apparatus of claim 12 further comprising a particulate filter to remove gross particulates from said raw wastewater.

14. The wastewater treatment apparatus of claim 1 further comprising a wastewater storage tank.

15. The wastewater treatment apparatus of claim 14 wherein said wastewater storage tank is an oil/water separator.

16. The wastewater treatment apparatus of claim 14 wherein said wastewater storage tank is a solids separator.

17. The wastewater treatment apparatus of claim 14 wherein said wastewater storage tank is an oil/water solids separator.

18. The wastewater treatment apparatus of claim 1 wherein said first and second ends of said filter media conveying means are elevated above a portion of said filter media conveying means disposed between said first and second ends.

19. The wastewater treatment apparatus of claim 18 wherein a float switch is provided, at said portion of the filter media conveying means which is disposed below said first and second ends, which activates said filter media conveying means to advance a segment of said filter media supported on said filter media conveying means.

20. A cleaning apparatus comprising:
a cleaning fluid supply;
a suction means; and
a wastewater treatment apparatus comprising:
a mixing tank;
a gravity bed filter including filter media, a filter media conveying means, and a filter media waste container; and
a clean water basin;
wherein wastewater introduced into said cleaning apparatus by said suction means and a flocculent are mixed within said mixing tank, and the mixture is transported to said gravity bed filter;
wherein said filter media is conveyed and supported by said filter media conveying means over said clean water basin;
wherein said mixture is transported to a first end of said filter media conveying means and disposed on said filter media so that clean water seeps from said mixture and through said filter media to collect in said clean water basin;
wherein said mixture is conveyed on said filter media to a second end of said filter media conveying means.

21. The cleaning apparatus of claim 20 herein said cleaning fluid supply comprises a water supply tank and a supply pump to supply water under pressure.

22. The cleaning apparatus of claim 21 wherein said cleaning fluid supply further comprises a boiler to supply said water at an elevated temperature or as steam.

23. The cleaning apparatus of claim 21 wherein said cleaning fluid supply further comprises an additive tank by which an additive may be added to said water.

24. The cleaning apparatus of claim 20 further comprising a surface cleaning implement fluidly connected to said cleaning fluid supply and said suction means.

25. The cleaning apparatus of claim 24 wherein said surface cleaning implement is a cleaning head.

26. The cleaning apparatus of claim 24 wherein said surface cleaning implement is a wand sprayer.

27. The cleaning apparatus of claim 24 wherein said surface cleaning implement is a brush.

28. The cleaning apparatus of claim 20 further comprising a filter media waste container in which said filter media and said mixture are collected at said second end of said filter media conveying means.

29. The cleaning apparatus of claim 20 further comprising a mixer in said mixing tank.

30. The cleaning apparatus of claim 20 wherein said filter media comprises a paper filter.

31. The cleaning apparatus of claim 20 wherein said filter media comprises a cloth filter.

32. The cleaning apparatus of claim 20 wherein said filter media comprises a fine mesh screen.

33. The cleaning apparatus of claim 20 wherein said filter media is continuously supplied from a filter media supply means.

34. The cleaning apparatus of claim 20 further comprising a particulate filter to remove gross particulates from said raw wastewater.

35. The cleaning apparatus of claim 20 further comprising a wastewater storage tank.

36. The cleaning apparatus of claim 35 wherein said wastewater storage tank is an oil/water separator.

37. The cleaning apparatus of claim 35 wherein said wastewater storage tank is a solids separator.

38. The cleaning apparatus of claim 20 wherein said clean water is transported from said clean water basin to said cleaning fluid supply.

39. A method of treating wastewater comprising the steps of:
collecting raw wastewater;
mixing said wastewater with a flocculent;
transporting said mixture onto a filter media supported by a filter media conveying means;
conveying said mixture to an end of said filter media conveying means as said mixture is continuously transported onto said filter media; and
collecting clean water which seeps from said mixture and through said filter media in a clean water basin.

40. The method of claim 39, further comprising the step of collecting said filter media and said mixture in a filter media waste container.

41. The method of claim 39, further comprising the step of continuously providing said filter media on said filter media conveying means from a filter media supply means.

42. The method of claim 39, further comprising the step of recycling said clean water for use in a cleaning operation.

43. The method of claim 39, wherein said mixture is transported onto a first end of said filter media conveying means, and conveying said mixture to a second end of said filter media conveying means.

44. The method of claim 39, wherein a first end and a second end of said filter media conveying means are elevated above a portion of said filter media conveying means disposed between said first and second ends.

45. The method of claim 44, further comprising the steps of:
providing a float switch at said portion of the filter media conveying means which is disposed below said first and second ends; and
advancing a segment of said filter media supported on said filter media conveying means when said switch is activated by an accumulation of said mixture.
